(19) United States
(12) Patent Application Publication
(10) Pub. No.: US 2004/0032108 A1
(43) Pub. Date: Feb. 19, 2004

(54) Ratchet crank

(76) Inventor: Jose P. Balajadia, New York, NY (US)

Correspondence Address: Jose P. Balajadia, 61-15 98 Street, Apt. 3J, Rego Park, NY, 11374, US

(21) Appl. No.: 10/637,916

(22) Filed: Aug. 9, 2003

Related U.S. Application Data
(63) Continuation of application No. 10/021,385, filed on Oct. 29, 2001.

(51) Int. Cl. B62M 9/00

(52) U.S. Cl. 280/236; 280/253

(57) ABSTRACT

A new use of a bicycle freewheel is for rotating a wheel's hub or a wheel's axle or a crankset's axle/spindle.

There are three Embodiments of the bicycle freewheel, namely:

Embodiment # 1 in FIG. 6: a bicycle crankset without the two cranks with pedals and instead a handle is attached at the right hand side of a crankset's axle/spindle. The chainwheel is connected to a bicycle freewheel's sprockets by a chain. The bicycle freewheel is attaching to a bicycle wheel's hub. In operation, the handle moves backward and forward taking with it the axle, the chainwheel, and the bicycle freewheel in the same motion.

Embodiment # 2 in FIG. 7: a bicycle crankset without the two cranks with pedals, and instead a bicycle freewheel with a handle is attached to the crankset's axle/spindle using an adapter. The chainwheel is connected to a bicycle freewheel by a chain. The bicycle freewheel is attaching to a bicycle wheel's hub. In operation, the handle moves backward and forward; but the axle, chainwheel, and the bicycle freewheel attaching to a wheel's hub do not move backwards; they only move forward.

Embodiment # 3 in FIG. 8: a bicycle freewheel with a chainwheel at the rotating drum, is centrally attaching to a crankset's axle/spindle using an adapter. A handle is attaching to the crankset's axle/spindle at the right hand side with the bicycle freewheel. In operation, the handle moves backward and forward taking with it in the forward movement the rotating drum with the chainwheel.

### CROSS-REFERENCE TO RELATED APPLICATIONS

This application is a continuation in part to application Ser. No. 10/021,385.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

(1) Field of the Invention

This invention pertains to a method of rotating a wheel's hub or a wheel's axle or a crankset's axle/spindle with a chainwheel by using a bicycle freewheel; and moving the rotating drum via its transmission gear which may be a handle or sprockets in a backward and forward manner.

(2) Description of Related Art

The two most relevant prior arts for this invention are; 1. a ratchet wrench and 2. a bicycle transmission system.

1. a ratchet wrench is a tool for loosening and tightening nuts and bolts by a backward and forward movement of its handle; without removal from where it is applied.

2. A bicycle transmission system has two components which are: a. a bicycle freewheel at the rear wheel's hub and b. a crankset. The bicycle freewheel is connected to a chainwheel in the crankset by a chain.

(a) A bicycle freewheel is a device measuring three inches in diameter and half an inch in thickness, FIG. 1. It has a body (4) having a central opening that is threaded (1) for attaching to a bicycle's wheel hub. It has a rotating drum (3) that occupies the outside periphery of the body. Sprockets (2) are attached to the rotating drum all around it. It has a mechanism that allows the rotating drum to turn freely in the counterclockwise direction; but takes with it the body when turning in the clockwise direction. On the other hand, the body is free to turn in the clockwise direction; but will take with it the rotating drum in the counterclockwise direction. By inverting the position of the bicycle freewheel, the reverse will happen. The rotating drum will turn freely in the clockwise direction; but will take with it the body in the counterclockwise direction. The body will be free to turn in the counterclockwise direction; but will take with it the rotating drum in the clockwise direction.

(b) A bicycle crankset has the following components: a bottom bracket with axle/spindle at both ends, a chainwheel attached at the right hand side; and a left and a right cranks with pedals attached at both ends of the axle/spindle, in opposite positions at 180 degrees. The cranks go in a circular path in rotating the axle. There are four quadrants in one cycle of the cranks which are: a first quadrant which is approximately 0 to 90 degrees, a second quadrant which is approximately 90 to 180 degrees and so on. At the top of the first quadrant, the crank is almost vertical in position and the leg is bent by almost by 90 degrees. As the pedal is pushed through the first and second quadrants, the leg extends until the end of the second quadrant where its fully extended. When the leg is bent as in the first quadrant, less power could be delivered by the leg making it hard to push the pedal. Later on, as the leg stretches, more power is delivered and pedal pushing becomes easier. Making the cranks longer should gain leverage but they are not practical to have because at the top of the first quadrant the leg would be more bent; and at the bottom of the second quadrant, the foot won't have full contact with the pedal. It is the object of this invention to make pedal pushing easier to do and thus reduce leg muscle fatigue and tiredness in the long run.

### BRIEF SUMMARY OF THE INVENTION

Pedal pushing is made easier to do by having longer cranks, because of leverage. With longer cranks, the legs are less bent and more extended allowing for more power to be delivered. Moving the longer cranks in a backward and forward manner means short work and quick rest for the legs which augers well for reducing leg muscle fatigue and tiredness.

### BRIEF DESCRIPTIONS OF THE SEVERAL VIEWS OF THE DRAWINGS

FIG. 1 is a side and perspective views of a bicycle freewheel, a prior art.

FIG. 2 is a side and perspective views of a ratchet wrench, a prior art.

FIG. 3 is a side and perspective views of an adapter for a wheel's hub of a different size from that of a bicycle.

FIG. 4A is a perspective view of an adapter for a wheel's axle.

FIG. 4B is a perspective view of an adapter for a crankset's axle/spindle.

FIG. 5 is a side view of a bicycle transmission system, a prior art.

FIG. 6 is a side view of Embodiment # 1.

FIG. 7 is a side view of Embodiment # 2.

FIG. 8 is a side view of Embodiment # 3.

FIG. 9 is a side and perspective views of a bicycle freewheel similar to embodiment # 3.

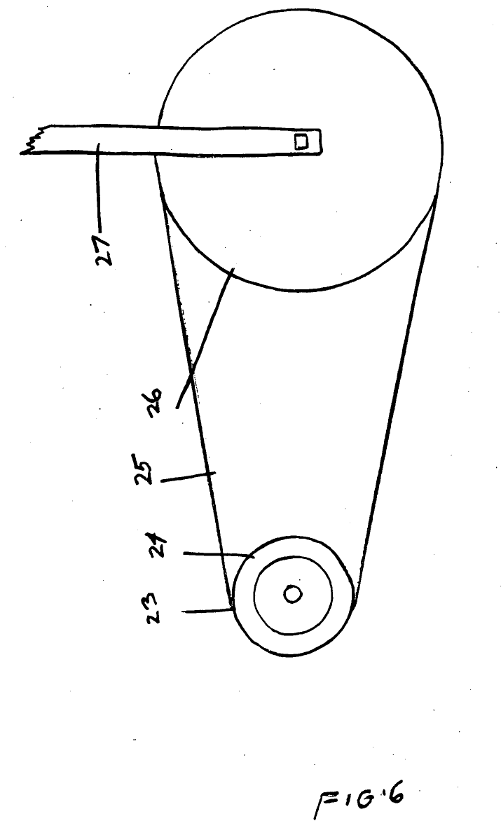

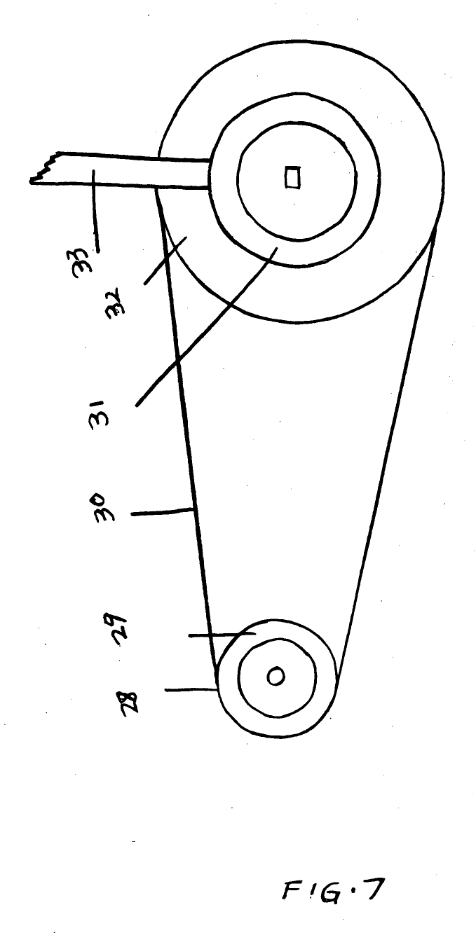

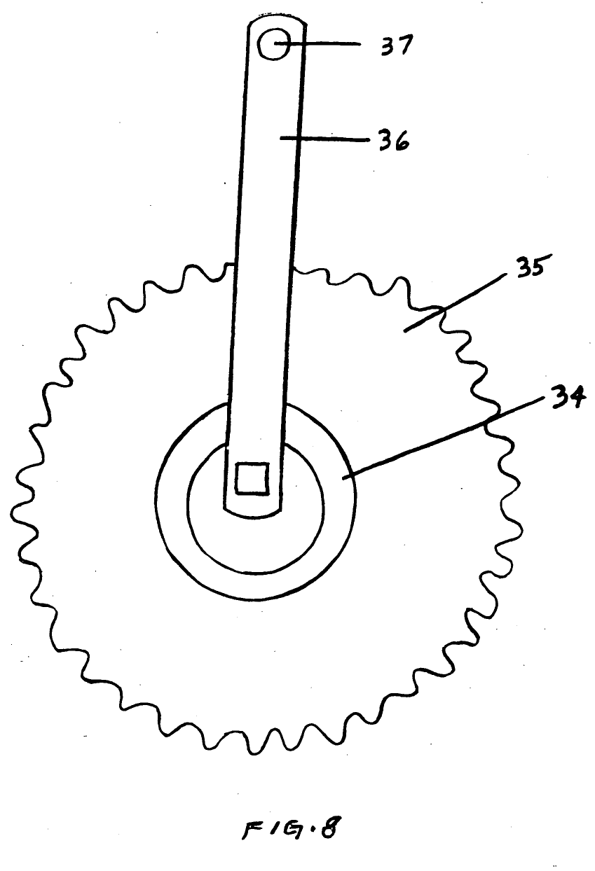

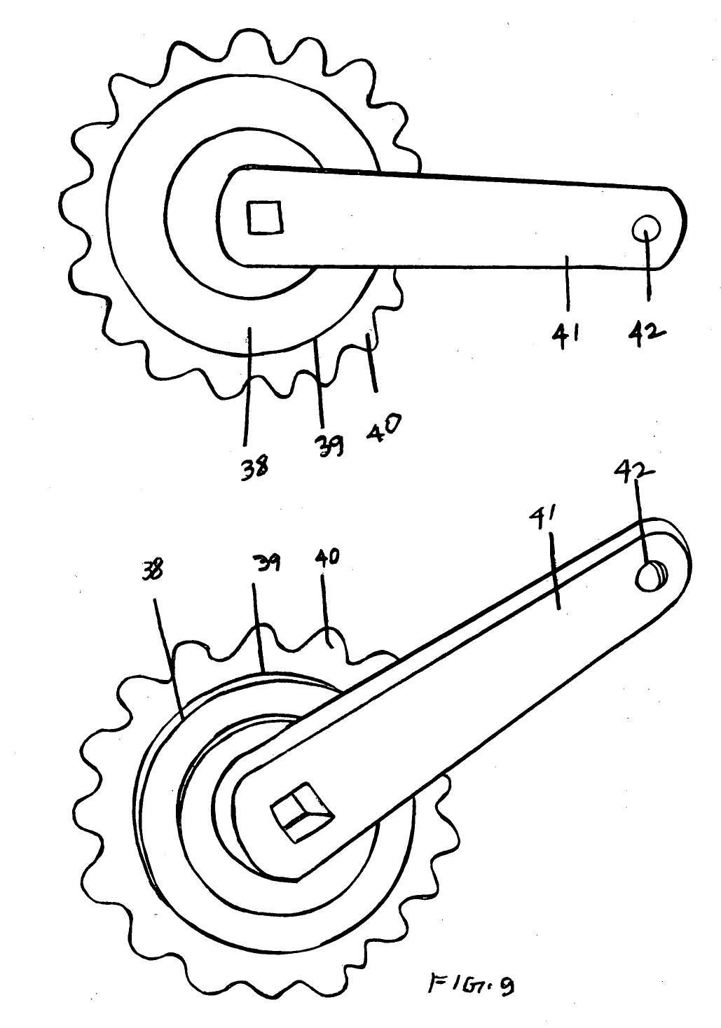

FIG. 6 and FIG. 7 have the same classification in that in both cases, the rotating drum takes with it the body. FIG. 8 and FIG. 9 have the same classification, in that in both cases, the body takes with it the rotating drum. They work in reverse.

### DETAILED DESCRIPTION OF THE INVENTION

The invention is a new use of a bicycle freewheel. The new use is: A method for rotating a wheel's hub or a wheel's axle or a crankset's axle/spindle in vehicle's on land and/or in water, using a bicycle freewheel, and moving the rotating drum via the sprockets or other attachments backward and forward or conversely, a backward and forward movement of the body will rotate the rotating drum together with any attachment to it.

There are three embodiments of the invention, namely:

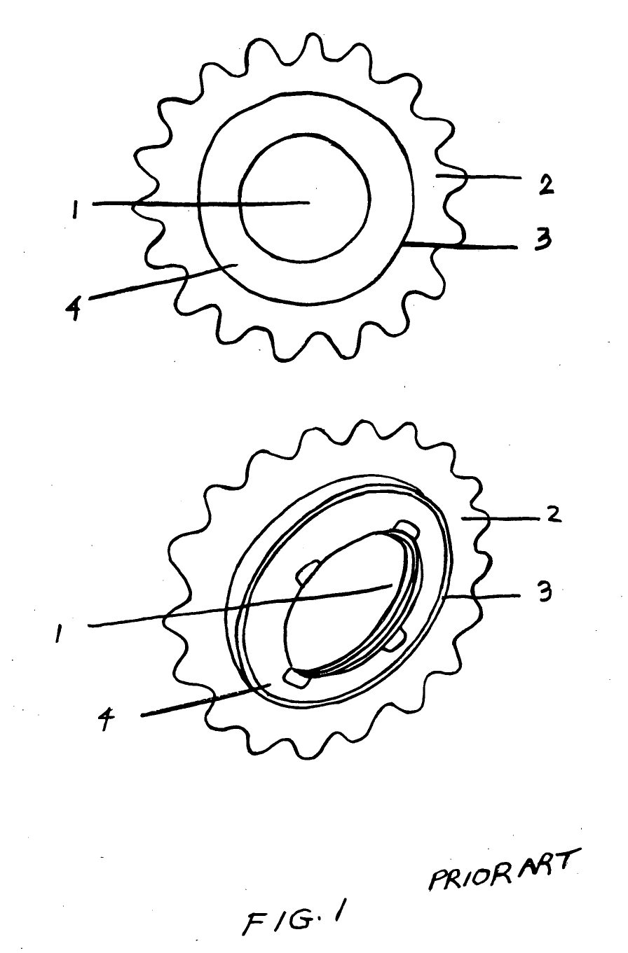

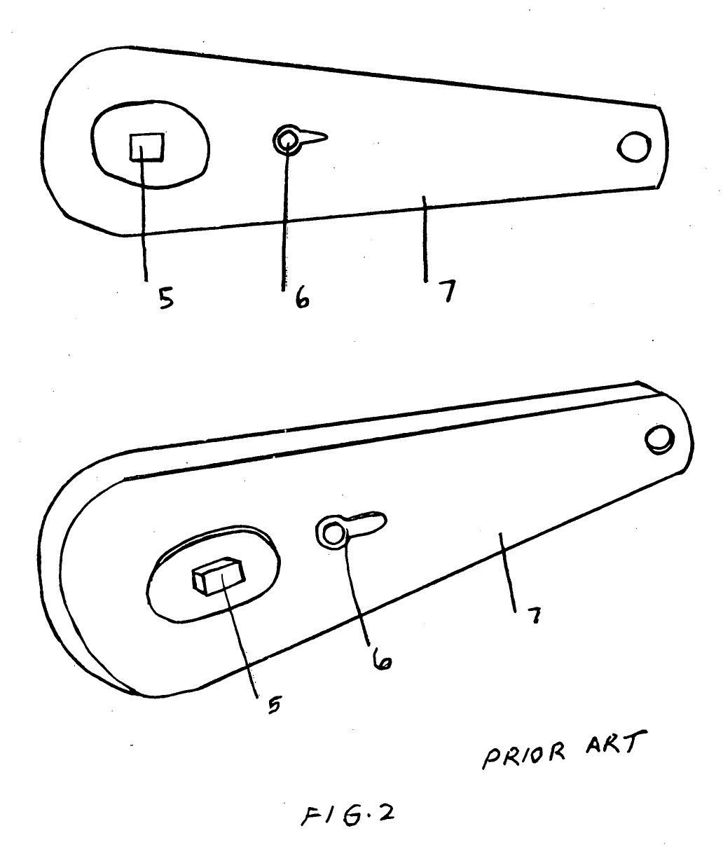

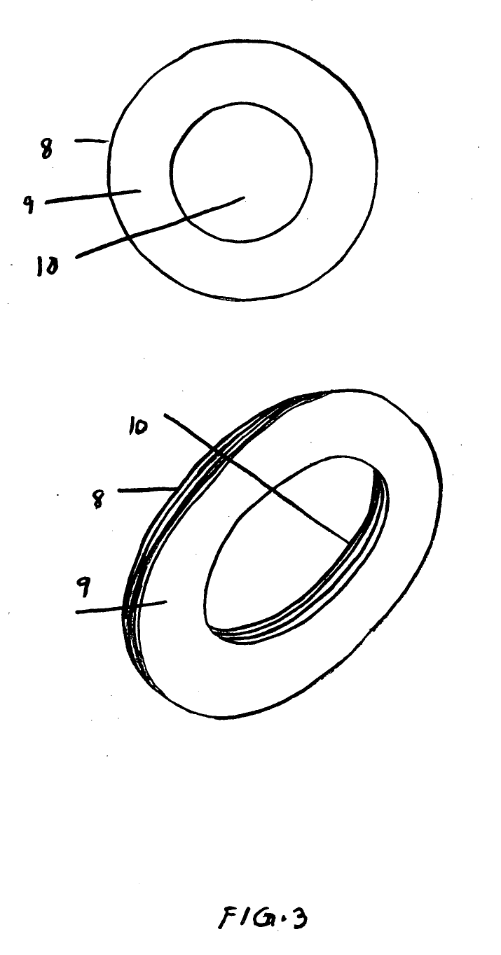

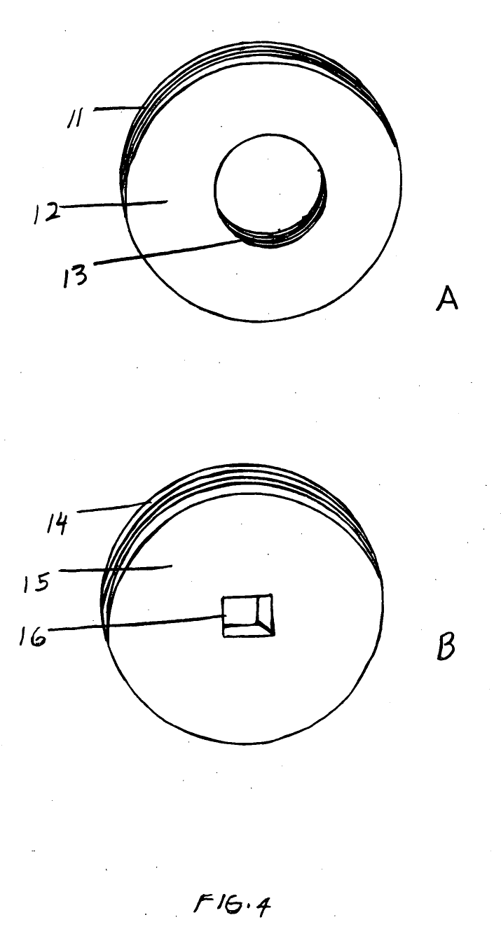

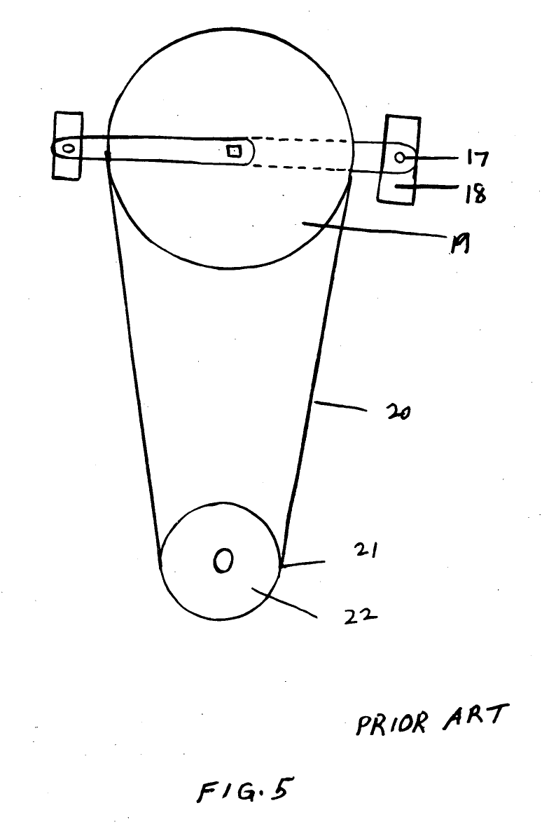

Embodiment # 1 is a bicycle freewheel, (FIG. 1). It is used to rotate a wheel's hub. For completeness, a crankset has a long handle, a chainwheel connected by a chain to it. A backward and forward movement of the long handle conveys the same motion to the bicycle freewheel; continuously turning the bicycle wheel's hub as in FIG. 6.

Embodiment # 2 is a bicycle freewheel with a handle at the rotating drum in lieu of the sprockets. It is used to rotate a crankset's axle/spindle. For completeness, an adapter is attached to the body and the crankets's axle/spindle. A backward and forward movement of the handle rotates the crankset's axle/spindle together with the chainwheel and the second bicycle freewheel at the bicycle wheel's hub, connected by a chain as in FIG. 7. It can be used also to rotate a wheel's hub or a wheel's axle.

Embodiment # 3 is a bicycle freewheel with a chainwheel at the rotating drum. For completeness, the bicycle freewheel is attached to a rotary axle or a crankset's axle/spindle. A handle is provided in order to move the body backward and forward while moving the axle in order to turn continuously the rotating drum and the chainwheel attached to it as in FIG. 8.

FIG. 9 is a side and perspective views of a bicycle freewheel centrally attaching to a crankset's axle/spindle using an adapter. A handle is attaching to the crankset's axle/spindle. In operation the handle moves backward and forward taking with it the rotating drum with the sprockets in the forward movement.

An adapter is needed when attaching to a wheel's hub with a different size from that of a bicycle's or a wheel's axle or a crankset's axle/spindle. An adapter is a round piece of metal which is threaded at its periphery for attaching to a bicycle freewheel's central opening. It has its own central opening that fits a wheel's hub of a different size or a wheel's axle or a crankset's axle/spindle.

For purposes of this invention, the rotating drum may have other attachments aside from the sprockets, such as a gear, a handle, a chainwheel, a belt, or other.

In attaching a handle to a bicycle freewheel, it was necessary to put an inverted U-shape hood over the sprockets to avoid destroying the mechanism. It is resting on the rotating drum all around. One inverted L shape part of the hood is placed on the left side and a straight metal piece is added at the right hand side, completing the inverted U shape. Four nuts and bolts were inserted, passing between the sprockets. They kept the two pieces of metals together. A handle was then welded on the surface of the hood.

As can be seen by the reader, a backward and forward movement of the bicycle freewheel will rotate a wheel's hub or a wheel's axle or a wheel's axle/spindle without rotation or, conversely a backward and forward movement of the body will continuously turn the rotating drum and its attachment.

While my above description contains many specificities, these should not be construed as limitations on the scope of the invention, but rather as an exemplification of three preferred embodiments thereof. Many other variations are possible. For example: other devices operated by a ratchet and pawl such as a ratchet wrench may be fashioned to be suitable and useful to be used.

In the manufacture of a bicycle freewheel, the sprockets are integrated to the rotating drum. In having a bicycle freewheel with a gear on the rotating drum, this can be made integrated just like the sprockets. In the case of a bicycle freewheel with a handle, a handle socket may be integrated to the rotating drum and varying length of handles may be attached to it. Handle lengths of 2-4 feet long may be operated with the hands; whereas those less than 1 foot may be attached with a pedal or foot, platform for operating with the feet. In the case of a bicycle freewheel with a chainwheel at the rotating drum, the rotating drum may be threaded and separately a chainwheel can be made threaded and attached to it. For purposes of this invention, the long handles may be operated by hands or feet or by mechanical or electrical means.

Under Embodiment # 3, a bicycle freewheel may have a rotating drum attached with any of the following: a chainwheel, or sprockets, or gear, or belt or a wheel or other.

Some applications in vehicles of the above are as follows: 1. A 3 to 4 feet long handle may be used in FIG. 6 and FIG. 7 to operate a scooter, 2. A bicycle freewheel with a long handle may be attached to both wheel's hub of a wheelchair and operated with the handles instead of rotating the wheel's with the hands, 3. FIG. 6 or FIG. 7 may be used in a boat or canoe and attached with paddle or propeller, and operated with the hands using the handle.

Accordingly, the scope of the invention should be determined not by the embodiments illustrated but by the appended claims and their legal equivalents.

I claim:

1) A method for rotating a wheel's hub in vehicles on land and/or in water, comprising:
(a) providing a bicycle freewheel;
(b) attaching said bicycle freewheel's body via its central opening to a bicycle wheel's hub;
(c) operating with means the bicycle freewheel so that the bicycle freewheel's body may be turned continuously, by a backward and forward movement of the bicycle freewheel's rotating drum via the sprockets.

2) The method of claim 1, wherein the bicycle freewheel is attaching to a wheel's hub with a different size from that of a bicycle's.

3) A method for rotating a wheel's hub or a wheel's axle or a crankset's axle/spindle in vehicles on land and/or in water, comprising:
(a) providing a bicycle freewheel with a handle at the rotating drum,
(b) attaching said bicycle freewheel's body via its central opening to a bicycle wheel's hub;
(c) operating with means the bicycle freewheel with a handle so that the bicycle freewheel's body may be turned continuously, by a backward and forward movement of said handle.

4) The method of claim 3, wherein the bicycle freewheel with a handle is attaching to a wheel's hub with a different size from that of a bicycle's.

5) The method of claim 3, wherein the bicycle freewheel is attaching to a wheel's axle.

6) The method of claim 3, wherein the bicycle freewheel with a handle is attaching to a crankset's axle/spindle.

7) A method for rotating a bicycle freewheel's rotating drum in vehicle's on land and/or in water, comprising:
(a) providing a bicycle freewheel with a chainwheel at the rotating drum;
(b) attaching said bicycle freewheel's body centrally to a rotary shaft or a crankset's axle/spindle or said bicycle freewheel's body;
(c) providing a handle, attaching said handle to said rotary shaft or said crankset's axle/spindle or said bicycle freewheel's body;
(d) operating with means said bicycle freewheel so that the rotating drum may be turned continuously, by a backward and forward movement of the handle.

8) The method of claim 7, wherein a wheel at the rotating drum is replacing the bicycle freewheel with a chainwheel.

9) The method of claim 7, wherein a bicycle freewheel with sprockets at the rotating drum is replacing the bicycle freewheel with a chainwheel.
